(19) United States
(12) Patent Application Publication
(10) Pub. No.: US 2025/0251552 A1
(43) Pub. Date: Aug. 7, 2025

(54) CABLE ASSEMBLY

(71) Applicant: Panduit Corp., Tinley Park, IL (US)

(72) Inventor: Benjamin J. Berridge, Griffith, IN (US)

(73) Assignee: Panduit Corp., Tinley Park, IL (US)

(21) Appl. No.: 19/037,627

(22) Filed: Jan. 27, 2025

Related U.S. Application Data
(60) Provisional application No. 63/550,691, filed on Feb. 7, 2024.

(51) Int. Cl. G02B 6/38

(52) U.S. Cl. CPC G02B 6/3885; G02B 6/3897

(57) ABSTRACT

A fiber optic cable assembly for connecting data center equipment together in different configurations to enable high data transmission.

### CROSS-REFERNCE TO RELATED APPLICATION(S)

The application claims benefit to U.S. Provisional Patent Application No. 63/550,691, filed on Feb. 7, 2024, the entirety of which is hereby incorporated by reference herein.

### TECHNICAL FIELD

The application relates to the field of fiber optic cable assemblies for connecting data center equipment together to enable data communication.

### BACKGROUND

As the data demands continue to increase across all different use cases and industries, the demand for the latest data transmission equipment capable of handling such higher data transmission rates also continues to increase.

Therefore, there is a need to create new cable assemblies that provide the proper cable pinouts and/or polarities to enable the connection of new configurations of data center equipment for handling these greater data transmission rates.

### SUMMARY

Disclosed herein are exemplary new cable assemblies that are configured to provide the proper cable pinouts and/or polarities to enable the connection of new configurations of data center equipment for handling greater data transmission rates.

A cable assembly is disclosed, the cable assembly comprising: a first end connector configured to connect to a first transceiver; a plurality of second end connectors each configured to connect to a second transceiver; and a conversion cable configured to couple the first end connector to the plurality of second end connectors.

A detailed description of these and other non-limiting exemplary embodiments of the cable assemblies is set forth below together with accompanying drawings.

### BRIEF DESCRIPTION OF THE DRAWINGS

FIG. 1 is an exemplary system diagram showing a cable assembly connecting a first optical transceiver at a first end to four distinct second optical transceivers at a second end, according to some embodiments.

FIG. 2 is an exemplary block diagram for a connector interface pin layout included in the first optical transceiver shown in FIG. 1, according to some embodiments.

FIG. 3 is an exemplary block diagram for a connector interface pin layout included in the second optical transceiver shown in FIG. 1, according to some embodiments.

FIG. 4 is a more detailed view of the cable assembly shown in FIG. 1, according to some embodiments.

FIG. 5 is a front view of an exemplary block diagram depicting a face of a connector comprising the first end of the cable assembly, according to some embodiments.

FIG. 6 is a front view of an exemplary block diagram depicting a face of a connector comprising the second end of the cable assembly, according to some embodiments.

FIG. 7 is an exemplary cable assembly pinout table describing the connection layout between the fiber pinout at the single connector on the first end of the cable assembly to the fiber pinouts at the four distinct connectors at the second end of the cable assembly, according to some embodiments.

FIG. 8 is a system diagram illustrating the fiber connection layout using the cable assembly pinout table shown in FIG. 7, according to some embodiments of the present disclosure.

### DETAILED DESCRIPTION

As required, detailed non-limiting embodiments are disclosed herein. However, it is to be understood that the disclosed embodiments are merely exemplary and may take various and alternative forms. The figures are not necessarily to scale, and features may be exaggerated or minimized to show details of particular components. Therefore, specific structural and functional details disclosed herein are not to be interpreted as limiting, but merely as a representative basis for teaching one skilled in the art.

Disclosed herein is a cable assembly for connecting optical transceivers at two different locations to enable high data rate data communication (e.g., 400 Gbps, hereinafter may be referred to as “400G” transmission rate) between the two locations. This cable assembly enables for unique data center equipment connection configurations to offer more versatility to installers of high data rate transmission systems.

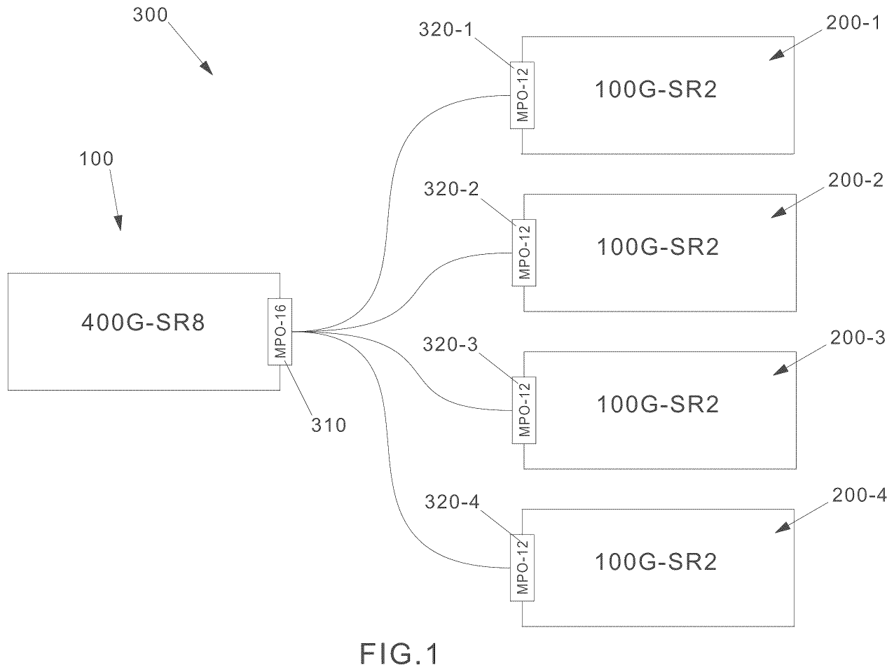

In the present disclosure, a data center equipment system 1000 as shown in FIG. 1 is provided. The system 1000 includes a single first optical transceiver 100 installed at a first location, four second optical transceivers 200-1, 200-2, 200-3, 200-4 installed at a second location, and a cable assembly 300 in-between to provide the connection between the first optical transceiver 100 and up to four of the second optical transceivers 200-1, 200-2, 200-3, 200-4. It shows that the cable assembly 300 is a 1-to-4 conversion cable assembly for connecting the single first optical transceiver 100 to up to four of the second optical transceivers 200, including a first second optical transceiver 200-1, a second second optical transceiver 200-2, a third second optical transceiver 200-3, and a fourth second optical transceivers 200-4.

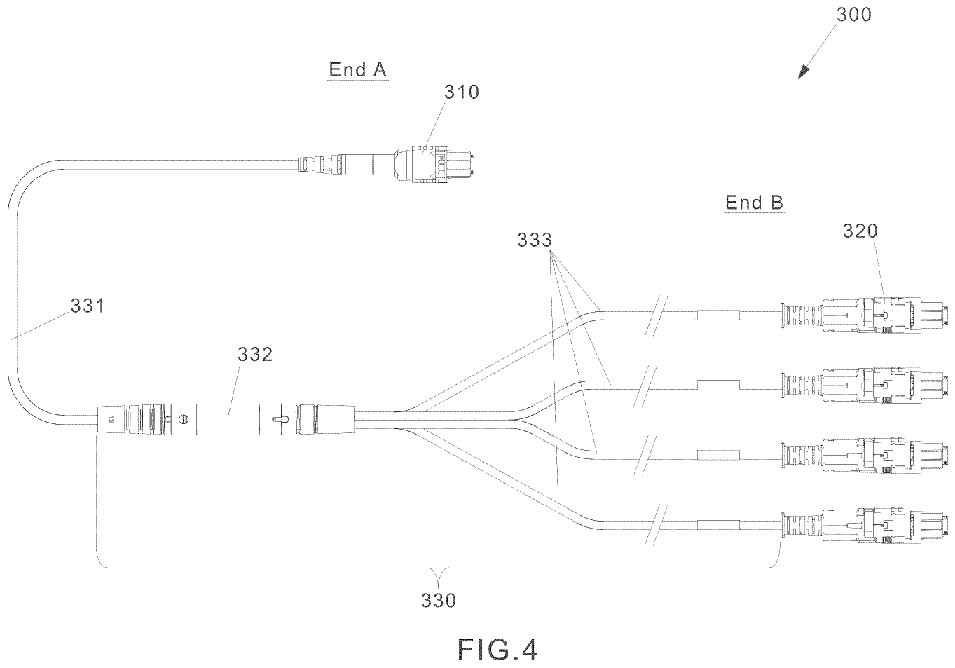

The cable assembly 300 includes a first connector 310 at a first end for connecting to the first optical transceiver 100, and up to four second connectors 320-1, 320-2, 320-3, 320-4 for connecting to the second optical transceivers 200-1, 200-2, 200-3, 200-4. FIG. 4 shows the cable assembly 300 in more detail, where the first connector may be an MPO-16 connector including sixteen (16) total fiber ferrule positions, and the second connector 320 may be an MPO connector utilizing four (4) active fiber ferrules. The cable assembly 300 also includes a conversion cable 330 between the first connector 310 and the second connectors 320. The conversion cable 330 includes a single cable portion 331 for carrying sixteen (16) fibers to the first connector 310, a breakout portion 332 where the sixteen (16) fibers are broken out into four (4) separate cables for each carrying four (4) fibers to each of the second connectors 320.

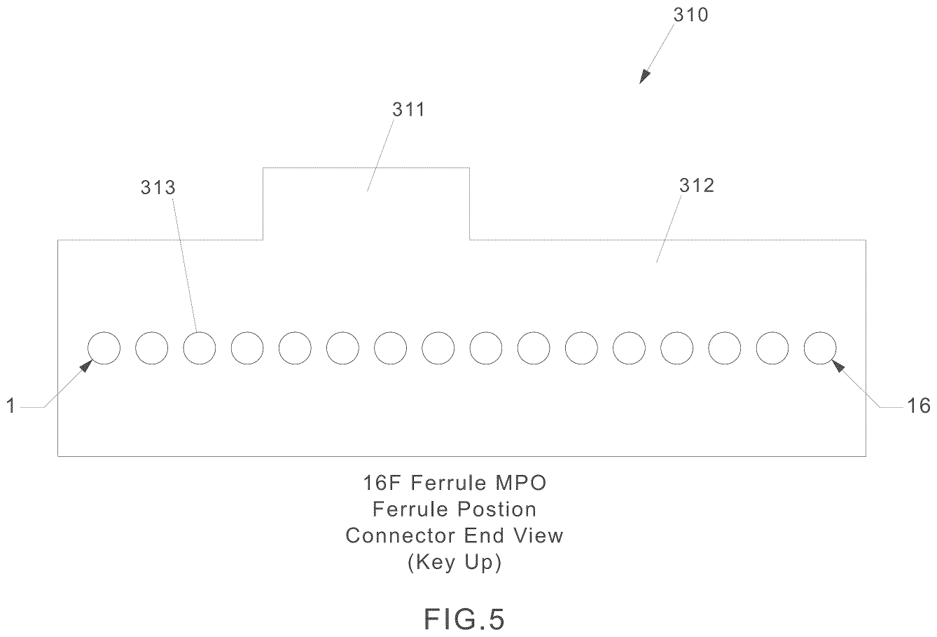

FIG. 5 shows an exemplary front face 312 of the first connector 310 included in the cable assembly 300, where the first connector 310 is configured to connect to the first optical transceiver 100. The front face 312 is shown to include a key up 311 design, and a single row of sixteen (16) fiber ferrules 313 that are identified by indices numbered from position 1-16. The first connector may be a sixteen (16) fiber MPO angled polished connector (MPO-16 APC).

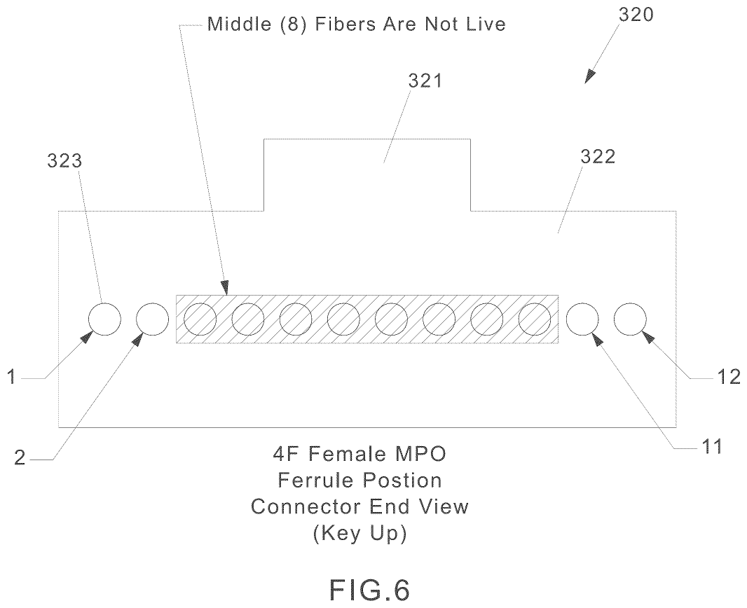

FIG. 6 shows an exemplary front face 322 of the second connector 320 included in the cable assembly 300, where the second connector 320 is configured to connect to the second optical transceiver 200. The front face 322 is shown to include a key up 321 design and include a single row of fiber ferrules 323. The second connector may be an MPO-4 APC including four (4) fiber ferrules, an MPO-8 APC utilizing four (4) fiber ferrules while leaving the remaining four (4) fiber ferrules inactive, or an MPO-12 APC utilizing four (4) fiber ferrules while leaving the remaining eight (8) fiber ferrules inactive as shown in FIG. 6. The fiber ferrules 323 being actively utilized in the second connector 320 may be the outer most fiber ferrules 323 on either side of the front face 322, while the fiber ferrules 323 being kept inactive may be the centermost fiber ferrules 323 as shown in FIG. 6.

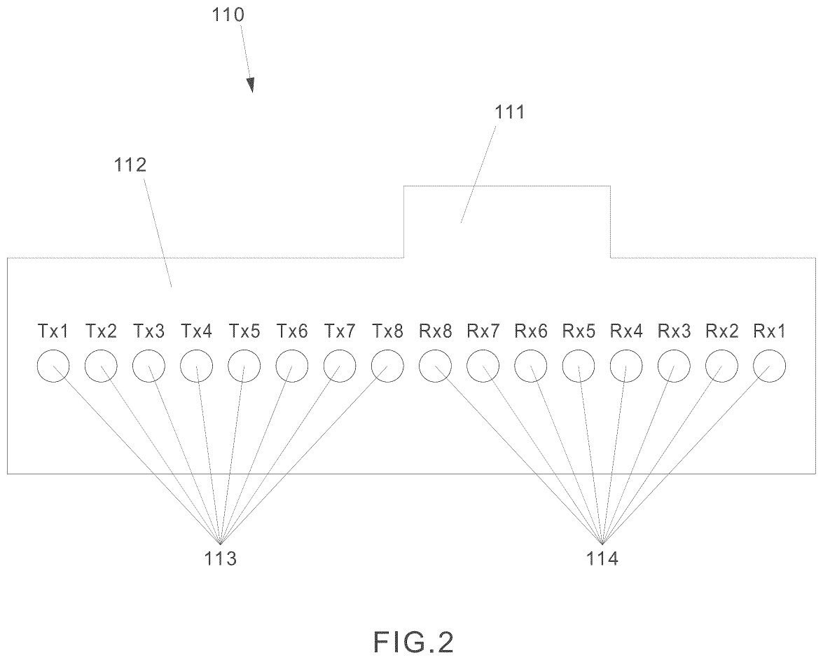

The first optical transceiver 100 may be a transceiver capable of achieving the 400G transmission rate, such as the QDD-400G-SR8. FIG. 2 shows an exemplary fiber connector interface 110 that may be included in the first optical transceiver 100. The fiber connector interface 110 includes a key up 111 design, and a front face 112 that includes a layout for sixteen (16) total fiber pins to transmit and receive data. A first set of pins 113 are configured to transmit data, while a second set of pins 114 are configured to receive data for the first optical transceiver 100.

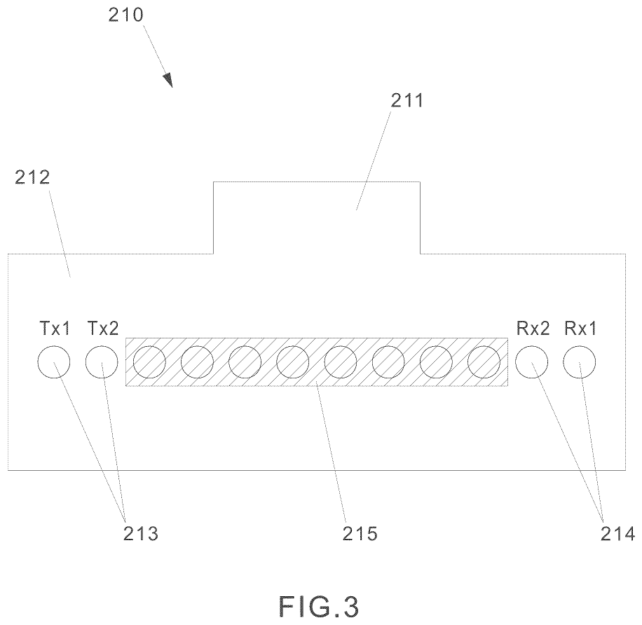

The second optical transceiver 200 may be a transceiver capable of achieving the 100G transmission rate, such as the QSFP28-100G-SR2. FIG. 3 shows an exemplary fiber connector interface 210 that may be included in the second optical transceiver 200. The fiber connector interface 210 includes a key up 211 design, and a front face 212 that includes a layout for twelve (12) total fiber pins to transmit and receive data. A first set of pins 213 are configured to transmit data, while a second set of pins 214 are configured to receive data for the second optical transceiver 200. A number of pins may be inactive in transmitting/receiving data. In the fiber connector interface 210, the centermost eight (8) pins are inactive, while the outermost pins are active in transmitting (e.g., first set of pins 213) and receiving (e.g., second set of pins 214) data. Although the fiber connector interface 210 is shown to include twelve (12) total pins, different pin layouts may also be included for other types of transceivers such as four (4) pins where all the pins are then utilized in either transmitting or receiving data, or eight (8) pins where the centermost four (4) pins are left inactive.

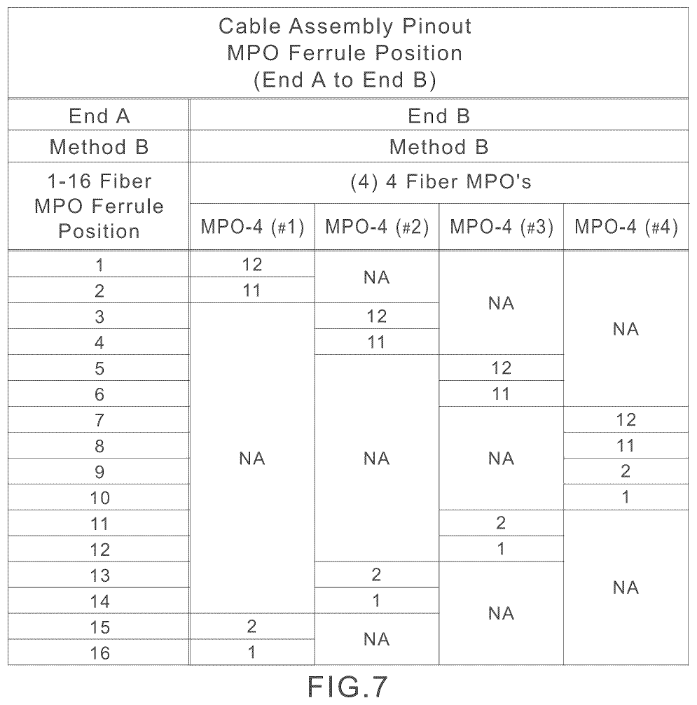

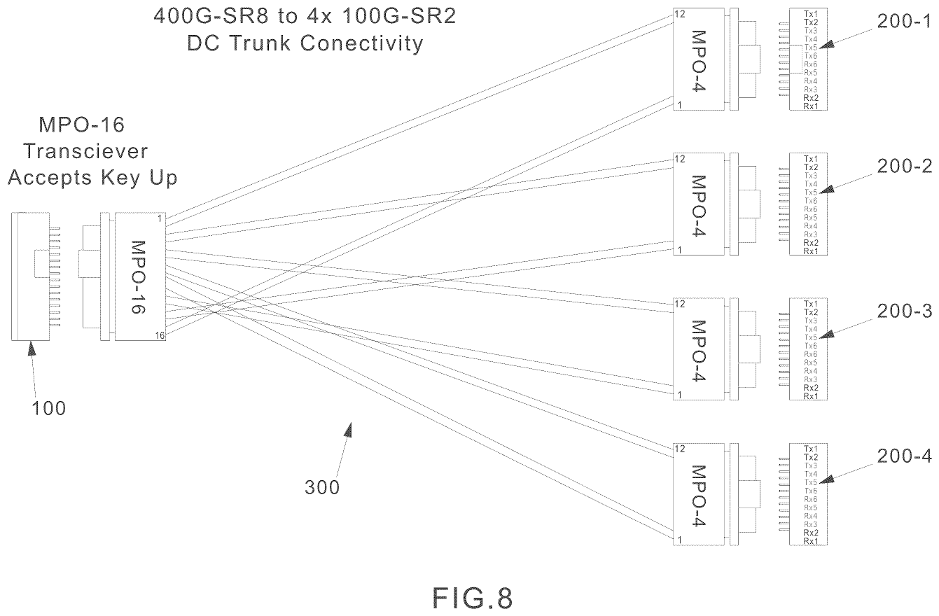

FIG. 7 shows a cable assembly pinout table 700 for configuring the fiber layout of the cable assembly 300. FIG. 8 shows an exemplary system diagram illustrating how the fiber layout may be implemented for the cable assembly 300 to follow the cable assembly pinout table 700.

The present disclosure thus describes systems, devices, and methods for implementing a cable assembly and a method for utilizing the cable assembly to connect transceivers at different locations. As is readily apparent from the foregoing, various non-limiting embodiments of the cable assembly system, device, and methods for utilizing the cable assembly have been described. While various embodiments have been illustrated and described herein, they are exemplary only and it is not intended that these embodiments illustrate and describe all those possible. Instead, the words used herein are words of description rather than limitation, and it is understood that various changes may be made to these embodiments without departing from the spirit and scope of the following claims.

What is claimed is:

1. A cable assembly comprising:
a first end connector configured to connect to a first transceiver;
a plurality of second end connectors each configured to connect to a second transceiver; and
a conversion cable configured to couple the first end connector to the plurality of second end connectors.

2. The cable assembly of claim 1, wherein the first transceiver is a 400G data transmission transceiver.

3. The cable assembly of claim 1, wherein the plurality of second end connectors includes four second end connectors each configured to connect to a 100G data transmission transceiver.

4. The cable assembly of claim 1, wherein the first end connector is an MPO-16 connector.

5. The cable assembly of claim 1, wherein the first end connector is an MPO-16 APC connector.

6. The cable assembly of claim 1, wherein the second end connector is an MPO-12 connector.

7. The cable assembly of claim 1, wherein the second end connector is an MPO-12 APC connector.

8. The cable assembly of claim 1, wherein the second end connector is an MPO-8 connector.

9. The cable assembly of claim 1, wherein the second end connector is an MPO-8 APC connector.

10. The cable assembly of claim 1, wherein the second end connector is an MPO-4 connector.

11. The cable assembly of claim 1, wherein the second end connector is an MPO-4 APC connector.
